(19) United States
(12) Patent Application Publication
(10) Pub. No.: US 2005/0229421 A1
(43) Pub. Date: Oct. 20, 2005

(54) Craft stencil

(76) Inventors: Marilyn S. Deas, Montague, CA (US); Michael L. Deas, Montague, CA (US)

Correspondence Address: Richard C. Litman;LITMAN LAW OFFICES, LTD., P.O. Box 15035, Arlington, VA, 22215, US

(21) Appl. No.: 10/824,602

(22) Filed: Apr. 15, 2004

(51) Int. Cl. G01B 3/14

(52) U.S. Cl. 33/563

(57) ABSTRACT

The craft stencil provides a fast, simple, and convenient way of marking a pattern onto the surface of a workpiece. Useful for, among other tasks, marking a temporary pattern onto a piece of cloth to guide stitching for a needlecraft, the craft stencil is an open mesh material having a coating applied to close the mesh of selected regions of the material, defining a pattern in the uncoated portions. In use, the craft stencil is placed on the surface of the workpiece, and a marking powder is applied to the workpiece surface through open areas in the craft stencil. Guidelines in the stencil transfer registration marks and directional arrows to the workpiece surface along with the pattern in order to assist in aligning the craft stencil and in correctly following the pattern while stitching.

### BACKGROUND OF THE INVENTION

1. Field of the Invention

The present invention relates to stencils for marking a pattern for sewing and other crafts. More particularly, the present invention is a craft stencil made of an open mesh material with areas of the open mesh closed, whereby remaining open areas define a line pattern, and to methods of making and using the stencil.

2. Description of the Related Art

In needlecrafts, such as quilting, needlepoint, embroidery, etc., as well as in painting and other crafts, it is often desirable to transfer a pattern, to the surface of a workpiece, which provides guidance during the craftwork. For example, in quilting, a pattern may be drawn or otherwise applied to a quilt surface to guide a quilter in stitching. Sign painters often apply a pattern to a sign surface before painting the sign so that the sign may be more accurately painted.

Such a pattern may be drawn directly on the workpiece by freehand. Alternatively, a stencil or template may be used to help in marking the pattern, the stencil or template assisting in creating a more precise and repeatable pattern.

In a technique used by sign painters and mural painters, a pounce pattern is used, along with a pounce bag or pad, to create a chalk-line design pattern on a surface. The pounce pattern is essentially a sheet of paper with a perforated line pattern “drawn” on the paper in the form of a series of perforations punched through the paper. A pounce wheel, which is a tool comprising a wheel with small sharp teeth or spikes, is rolled along the surface of the paper as its teeth or spikes punch through the paper to form the perforated line pattern. The completed pounce pattern is held flat against the surface of the workpiece and a fine powder from the pounce bag or pad, such as chalk, is applied, marking the design pattern on the workpiece through the perforations in the paper. While this technique is effective in transferring a design pattern to the surface of a workpiece, the production of the pounce pattern itself is tedious and not well suited for manufacture of a significant quantity of pounce patterns. Additionally, for certain applications such as quilting, it is preferable to have a design pattern marked in a continuous, full line form rather than as the series of points created by the pounce pattern.

Templates have been used to mark stitching patterns on fabric for needlecrafts. Often, such a template is a sheet of plastic or metal, into which is cut a line pattern. The template is placed on the fabric, and the pattern is drawn using a pencil or other marker guided by the template's line pattern. For a large or complex pattern, this process can be tedious, as each of the pattern's lines must be individually traced with the aid of the template. The template must be carefully held in place during the process, so that the template does not change position while the pattern is being-drawn. The-lines cut into the plastic or metal sheet must have breaks where “bridges” are required to hold together pieces of the template that would otherwise fall apart. Often, after all of the template's line portions have been drawn, these breaks must be filled in to complete the pattern.

U.S. Pat. No. 4,483,265, issued on Nov. 20, 1984 to K. Weidmann, discloses a cross-stitch design process wherein a rubber stamp which will imprint a cross is used to mark on a piece of cloth a cross-stitching pattern that has been sketched on a piece of quadrille paper. The cross printed by the rubber stamp corresponds to the grid size of the quadrille paper, simplifying the process of duplicating on the cloth the pattern sketched on the quadrille paper.

Various stitching guides have been used in needlecrafts. U.S. Pat. No. 207,141, issued on Aug. 20, 1878 to R. Smith, discloses an embroidery pattern wherein a piece of cardboard is perforated at regular intervals, the perforations forming a pattern or design. A piece of cloth corresponding in size and shape to the cardboard is secured to one side of the cardboard, the cloth laying smoothly on the surface of the cardboard. The perforations in the cardboard indicate the exact figure to be worked, and moreover indicate the exact position for each stitch. In use, a needle threaded with an embroidering thread is passed through each perforation in the cardboard and drawn through the cloth.

U.S. Pat. No. 1,560,283, issued on Nov. 3, 1925 to E. Mehlem, discloses a stencil embroidery pattern wherein a number of cutouts are made in a paper pattern sheet to define an embroidery pattern. The pattern sheet is supported on a piece of cloth, the cloth being of a contrasting color. In use, a netting to be embroidered is placed over the pattern sheet, the cutout pattern being visible through the netting. The netting is embroidered following the cutout pattern.

U.S. Pat. No. 6,155,189, issued on Dec. 5, 2000 to H. Walner, discloses a stitching guide comprising a flexible sheet into which elongated perforations are cut to form a design. Each of the perforations is elongated, and separated from successive perforations in line by a connector. The stitching guide is attached to a fabric, and stitching is sewn along the perforations. When the design is completely stitched, the stitching guide is removed from the fabric by breaking the connectors apart along the line of the perforations. The stitching guide is not, however, used to mark a pattern on the fabric. Given the inherently fragile nature of the stitching guide, in that it is designed to break apart along the line of perforations, it is not suitable for use as a marking template.

Silk screens are widely used in printing. However, conventional silk screening, using paints or inks, is not suited to the temporary markings that a quilter, for instance, would apply to a fabric as a stitching guide. Additionally, conventional silk screens are used mounted in a frame, stretched taut for optimal image transfer. This limits the ability of a conventional silk screen to be used for needlework, where the surface to be marked is often not flat, such as the surface of a pillow or cushion.

U.S. Pat. No. 3,507,652, issued on Apr. 21, 1970 to R. Wrench, discloses a thin emulsion stencil screen and method. The screen is formed basically by applying a photosensitive emulsion to coat and permeate a pre-stretched screen, the screen being bonded to a frame. A pattern is photographically exposed onto the emulsion, and the emulsion is developed to remove unexposed portions of the emulsion from the screen.

U.S. Pat. No. 5,518,803, issued on May 21, 1996 to R. Thomas, discloses a spray-painting technique using a printing screen.

U.S. Pat. No. 4,278,022, issued on Jul. 14, 1981 to J. Fitzpatrick, discloses a photographic image painting process in which a printing screen is removed from its frame after the production of the screen. The screen is secured to a surface with masking tape, and spray paint is applied to produce an image on the surface.

None of the above inventions and patents, taken either singly or in combination, is seen to describe the instant invention as claimed. Thus, a method of transferring stencils solving the aforementioned problems is desired.

### SUMMARY OF THE INVENTION

The craft stencil of the present invention provides a fast, simple, and convenient means for marking a pattern onto the surface of a workpiece. The craft stencil is an open mesh material having a coating applied to close the mesh of selected regions of the material, thereby defining a pattern. In use, the craft stencil is placed on the surface of the workpiece, and a marking powder is applied to the workpiece surface through open areas in the craft stencil.

The craft stencil draws on conventional silkscreen techniques for its production. An open mesh material is coated with a photosensitive emulsion. Artwork defining the desired stencil pattern, printed in black ink on a transparent material, is laid on top of the coated mesh. The emulsion-coated mesh, not obscured by the stencil pattern, is then exposed to light. The mesh is then processed to remove unexposed emulsion. The result is that the mesh openings of the material are generally closed, but open areas are created to define the stencil pattern.

While this basic process is similar to techniques used in conventional silkscreen production, the use of the craft stencil with a marking powder such as chalk or pounce powder, instead of inks or paints, dictates certain differences that can be exploited to create craft stencils more easily and economically.

In conventional silkscreen printing, it is desirable to achieve high image quality through the use of a fine mesh screen, and by producing and using the screen under tension. Additionally, the conventional printing silkscreen must be durable in order to withstand the repeated stress of forcing paint or ink through the screen with a squeegee or similar tool. Thus, a conventional silkscreen for printing is characterized by a mesh having a relatively high thread count, both to withstand tensioning of the screen and for improved print resolution. Additionally, a conventional silkscreen for printing employs multiple emulsion coats, often applied to both sides of the mesh, both for improved wear resistance and durability and to ensure that there are no flaws or pinholes in the emulsion that might cause spots on the print, deteriorating the print quality.

In contrast, the craft stencil may be formed with a mesh having a low thread count coated with a single, thin layer of emulsion. A low thread count is desirable for improved transfer of the marking powder through the craft stencil. A higher thread count is not necessary, since the need for image detail and sharpness is not as great for a craft stencil used for simple pattern marking. Because the craft stencil is used to apply a temporary pattern to a workpiece surface, there is no negative consequence to spots or marks caused by pinholes in the emulsion coating. Therefore, a single thin layer of emulsion may be used without concern for imperfections in the coating. An additional advantage of the single, thin coat of emulsion is that the craft stencil may be made semi-transparent, making it easier for a user to align the craft stencil with markings on the workpiece surface.

Because the craft stencil is used for temporary marking, the stencil's pattern may include markings, such as registration marks or directional arrows, which assist in the use of the craft stencil. Transferred onto the workpiece surface, registration marks facilitate location of the stencil to mark repeating patterns, while directional arrows assist a needle crafter in following the pattern in the correct direction while stitching.

These and other features of the present invention will become readily apparent upon further review of the following specification and drawings.

### BRIEF DESCRIPTION OF THE DRAWINGS

FIG. 1 is an environmental, perspective view of a craft stencil according to the present invention.

FIG. 2 is a section view of a craft stencil according to the present invention.

FIG. 3 is a plan view of a craft stencil according to the present invention.

FIG. 4 is a plan view of a craft stencil according to the present invention, showing additional stencil features.

Similar reference characters denote corresponding features consistently throughout the attached drawings.

### DETAILED DESCRIPTION OF THE PREFERRED EMBODIMENT

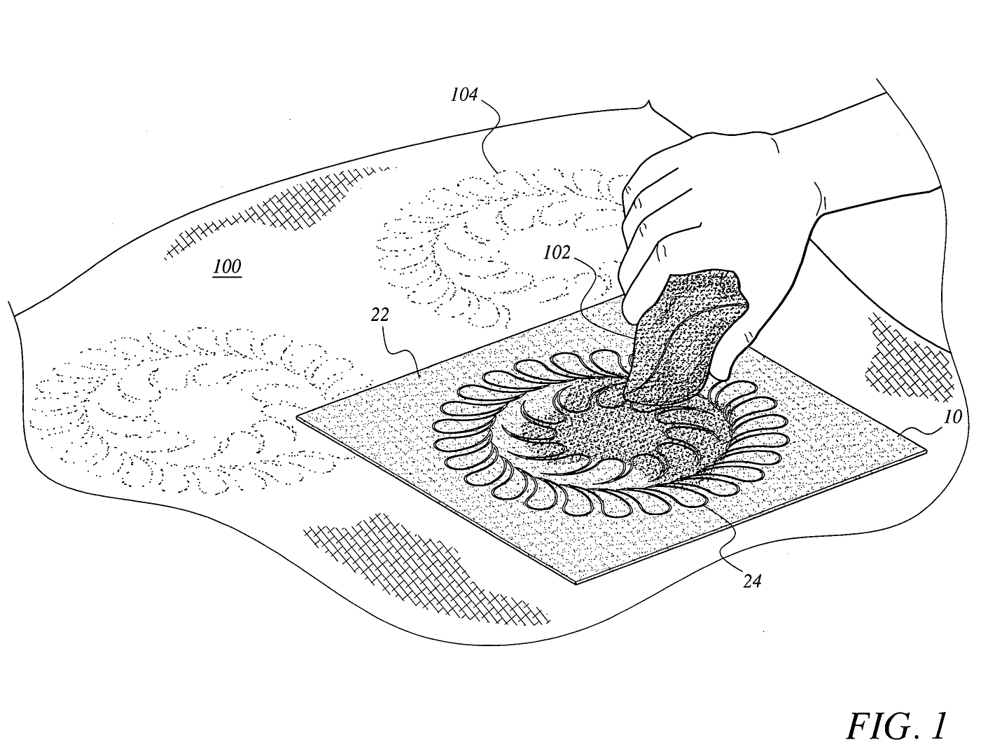

The present invention is a craft stencil, designated generally as 10 in the drawings, and a method for making and using the craft stencil 10. Referring to FIG. 1, the craft stencil 10 is shown in use while marking a temporary pattern 104 on a surface 100 of a workpiece. The craft stencil 10 is placed on the workpiece surface 100, while a marking powder such as chalk or a pounce powder is applied by a marking powder applicator 102 such as a chalk bag or a pounce pad. The marking powder contacts the workpiece surface 100 through open areas 24 of the craft stencil 10, marking a pattern 104 on the workpiece surface 100.

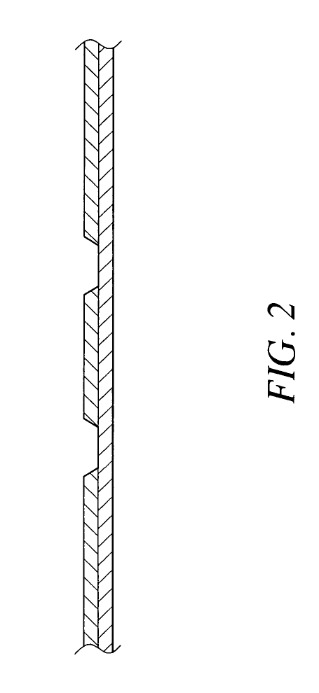

Turning to FIG. 2, the craft stencil 10 comprises a sheet of open mesh material 20. Areas of the open mesh material 20 are covered with a photosensitive emulsion 22 that closes the mesh. Between the areas of the open mesh material 20 covered by the photosensitive emulsion 22 are open areas 24, where the mesh is left open. The open areas 24 define the craft stencil's 10 pattern.

The thread count and mesh opening size of the open mesh material 20 are selected for compatibility with a marking powder, it being desirable that the marking powder passes readily through the open areas 24 of the craft stencil 10 to effectively mark a work product surface 100. The open mesh material 20 may be cloth, plastic, or metal, depending on various factors, such as the size of the pattern, the level of quality and detail desired, and the intended lifespan of the completed craft stencil 10.

A preferred open mesh material 20 is a polyester monofilament mesh having a thread count of 40 to 195 threads per inch (TPI). At lower thread counts, the open mesh material 20 has larger openings that allow for greater contact of a marking powder applicator 102 through the craft stencil 10 with a workpiece surface 100, improving the clarity and quality of a transferred image. Additionally, low thread count facilitates infiltration of the photosensitive emulsion 22 into the fibers of the open mesh material 20 during manufacture of the craft screen 10. In can be recognized, however, that materials having a thread count that is too low sacrifice image detail, and may be difficult to adequately and uniformly coat with the photosensitive emulsion 22.

Conversely, materials having a higher thread count may provide image detail that is unnecessary or cannot be practically utilized with marking powders, or may require use of specialized marking powders having a smaller particle size. At higher thread counts, the openings of the open mesh material 20 allow less contact of a marking powder applicator 102 through the craft stencil 10 with a workpiece surface 100, diminishing the clarity and quality of a transferred image. Higher thread count materials are also more costly.

Utilizing a polyester monofilament mesh for the open mesh material 20 creates a craft stencil 10 with the flexibility of cloth, which is advantageous when the craft stencil 10 is to be used on a contoured surface where, for optimal marking on the surface, the craft stencil 10 must be able to conform to the surface contours.

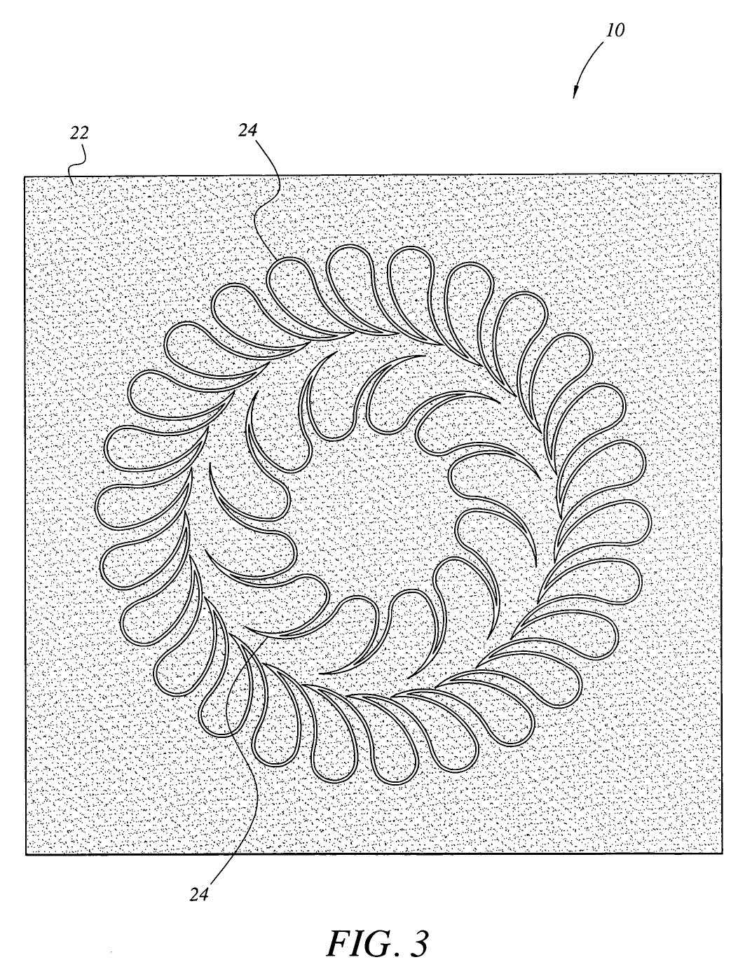

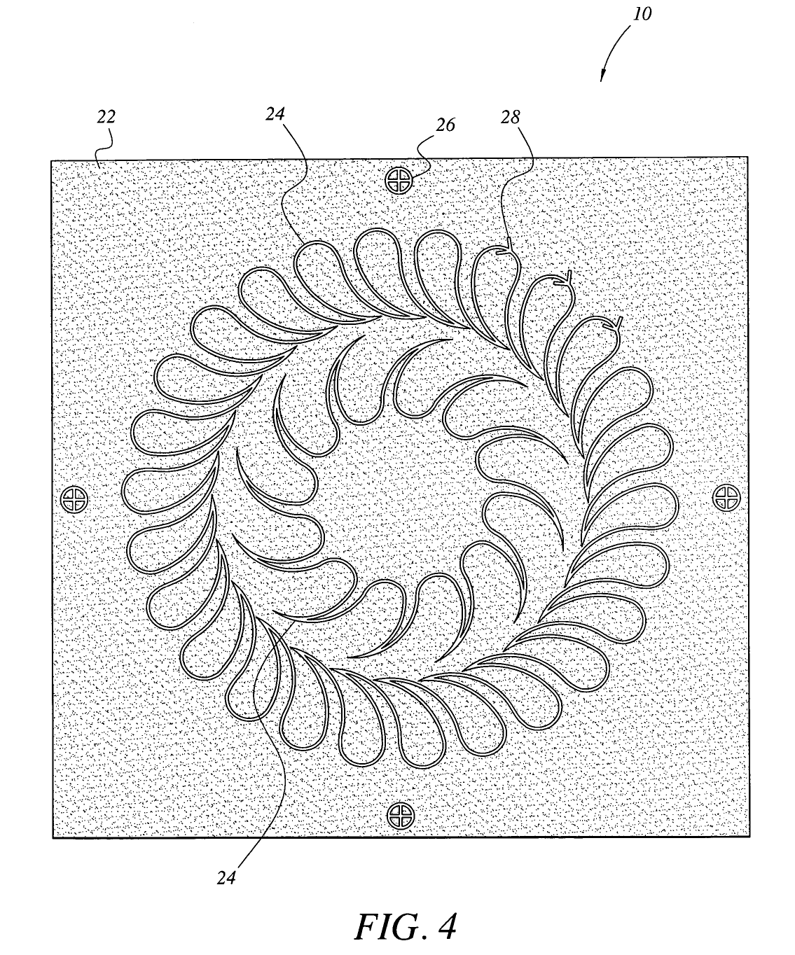

Turning now to FIGS. 3 and 4, a craft stencil 10 pattern, defined by the open areas 24, is shown to be illustrative of the type of line patterns useful in quilting and other needlecrafts. The pattern is characterized by the continuous-line style of the pattern. It is noteworthy to observe that, because of the nature of the craft stencil 10, the continuous-line pattern has no breaks, as would be required in a plastic cut stencil or similar type of stencil, wherein a continuous-line pattern would be interrupted by the many small “bridges” necessary to maintain the structural integrity of the stencil.

Because the craft stencil 10 is used to apply temporary markings to a workpiece surface 100, the markings may include guidelines or other assistive or instructive features, including registration marks 26 and directional arrows 28 to assist in the use of the craft stencil 10. The registration marks 26 facilitate marking multiple patterns onto a workpiece surface 100, as may be desirable in marking multiple blocks of a quilt. Directional arrows 28 may be defined in the craft stencil 10 pattern to guide a quilter in stitching in a correct, or optimal, direction to follow the pattern.

The craft stencil 10 is produced by applying a single thin layer of a photosensitive emulsion 22 to a sheet of open mesh material 20. In contrast to conventional silkscreen production, the open mesh material 20 is not pre-stretched or maintained under tension during or after production of the craft stencil 10. The layer of photosensitive emulsion 22 is sufficient to substantially close the mesh openings of the open mesh material 20, although it is not necessary that all of the mesh openings are completely closed. Because the craft stencil 10 is used for application of temporary markings, small imperfections such as pinholes in the layer of photosensitive emulsion 22 are generally inconsequential.

Artwork to become the stencil pattern is printed on a sheet of transparent material in black ink (or any suitable opaque printing material), and laid on the emulsion-coated mesh, the printed pattern covering areas of the emulsion-coated mesh. The emulsion-coated mesh not covered by the printed pattern is exposed to a light source for a sufficient time interval, based on the type of emulsion and the type of light source, to photographically expose the emulsion. The areas of the emulsion-coated mesh underneath the printed pattern of the artwork remain unexposed. After exposure, the artwork is removed from the emulsion-coated mesh and the emulsion-coated mesh is processed to remove the unexposed emulsion from the open mesh material 20. Typically, the emulsion-coated mesh is processed by rinsing the unexposed emulsion from the open mesh material 20 with water. The result is that the open mesh material 20 has substantial areas that remain closed by the photosensitive emulsion 22, and open areas 24 where the emulsion was removed defining the craft stencil 10 pattern.

When a semi-transparent emulsion is used to produce a craft stencil 10, and the open mesh material 20 has a sufficient mesh opening size, the craft stencil 10 itself is semi-transparent. A semi-transparent craft stencil 10 is advantageous because the semi-transparency of the craft stencil 10 allows the craft stencil 10 to be more easily aligned in use with various markings or features on a workpiece surface beneath the craft stencil 10.

It is to be understood that the present invention is not limited to the embodiment described above, but encompasses any and all embodiments within the scope of the following claims.

1. A craft stencil, comprising:
a sheet of open mesh material;
a coating applied to portions of the mesh material, wherein coated portions of the mesh material are substantially impermeable to particulate matter and uncoated portions of the mesh material define a pattern permeable to particulate material, the pattern including at least one guideline;
whereby when the sheet is placed upon a workpiece and a powder applicator is applied to the stencil, the powder passes through the uncoated portions of the mesh material and transfers the pattern to the workpiece.

2. The craft stencil according to claim 1, wherein said at least one guideline comprises at least one registration mark.

3. The craft stencil according to claim 1, wherein said pattern comprises at least one continuous line.

4. The craft stencil according to claim 3, wherein said at least one guideline comprises at least one directional arrow disposed on said at least one continuous line.

5. The craft stencil according to claim 1, wherein said open mesh material is a polyester monofilament mesh.

6. The craft stencil according to claim 1, wherein said open mesh material has a thread count of between about forty to one hundred ninety threads per inch.

7. The craft stencil according to claim 1, wherein said coating is semi-transparent.

8. A method of making a craft stencil, comprising the steps of:
providing an untensioned sheet of an open mesh material;
applying a single, thin layer of a photosensitive emulsion to one side of said material;
overlaying said material with a transparent sheet, the transparent sheet having a pattern opaquely printed on a surface thereof, the pattern covering corresponding areas of said material;
exposing areas of said emulsion not covered by said pattern to light while leaving emulsion covered by said pattern substantially unexposed;
removing said transparent sheet from said material; and
removing said unexposed emulsion from said material.

9. The method of making a craft stencil according to claim 8, wherein said pattern comprises at least one guideline.

10. The method of making a craft stencil according to claim 8, wherein said at least one guideline comprises at least one registration mark.

11. The method of making a craft stencil according to claim 8, wherein said pattern comprises a plurality of lines.

12. The method of making a craft stencil 11, wherein said at least one guideline comprises at least one directional arrow disposed on at least one of said lines.

13. The method of making a craft stencil according to claim 8, wherein photosensitive emulsion is semi-transparent.

14. A craft stencil formed by the method of claim 8.

15. A method of using a craft stencil, comprising the steps of:
providing a craft stencil, the craft stencil comprising a sheet of open mesh material, there being a substantially impermeable coating applied to portions of said material, whereby remaining uncoated portions of the material define a pattern;
positioning said craft stencil on a surface of a workpiece;
applying a marking powder to said craft stencil, the marking powder contacting the surface of said workpiece through said uncoated areas of said craft stencil; and
removing said craft stencil from the surface of said workpiece.

16. The method of using a craft stencil according to claim 15, wherein said marking powder is applied to the surface of said workpiece using a marking powder applicator.

17. The method of using a craft stencil according to claim 16, wherein said marking powder contacts the surface of said workpiece through said uncoated areas of said craft stencil.

18. The method of using a craft stencil according to claim 15, wherein said pattern includes at least one guideline.

19. The method of using a craft stencil according to claim 18, further comprising the step of using said at least one guideline to align said craft stencil with markings or features on the surface of said workpiece.
